(19) United States
(12) Patent Application Publication
(10) Pub. No.: US 2021/0256788 A1
(43) Pub. Date: Aug. 19, 2021

(54) SMART KEY AND ACCESS MANAGEMENT

(71) Applicant: CARRIER CORPORATION, Palm Beach Gardens, FL (US)

(72) Inventors: Hrishi EATHAKOTA, Hyderabad, Telangana (IN); Suresh Raju BETHALAM, Hyderabad, Telangana (IN)

(21) Appl. No.: 17/251,577

(22) PCT Filed: Jul. 25, 2019
(86) PCT No.: PCT/US2019/043343

§ 371 Date: Dec. 11, 2020

(30) Foreign Application Priority Data
Sep. 25, 2018 (IN) 201811035985

(51) Int. Cl. G07C 9/00

(52) U.S. Cl. CPC G07C 9/00571; G07C 2209/62; G07C 9/00309

(57) ABSTRACT

An illustrative example access management device includes a processor, memory associated with the processor, a receiver configured to receive wireless communications, and a transmitter configured to wirelessly communicate with other devices. The memory contains an application. The receiver receives an access request from a user device and the transmitter wirelessly communicate payload to a lock for unlocking the lock when the processor invokes the application in the memory and thereby determines that the received access request is an authorized request.

### BACKGROUND

There are various situations in which access to a locked building is needed by someone other than the building owner. For example, when a home is offered for sale potential buyers and real estate agents require access to the home to view its interior. For many years lock boxes have been available to hold a physical key that allows such individuals to unlock a door to the home. Traditional lock boxes require manually entering a code, which is usually a sequence of numbers, on a keypad to open the lock box to retrieve the key. Before leaving, the individual who used the key replaces it in the lock box.

With advances in electronics it has become possible to eliminate the need to manually enter a code on a keypad of a lock box. Instead, it is now possible to open a lock box using a mobile device, such as a cell phone, to provide an authorization code to open the lock box. The eKey products and services offered by United Technologies allow individuals to open lock boxes through a cell phone or another mobile device.

With either approach mentioned above, a physical key may be retrieved from a lock box. There are situations, however, in which the lock to be opened does not require or accept a physical key.

### SUMMARY

An illustrative example access management device includes a processor, memory associated with the processor, a receiver configured to receive wireless communications, and a transmitter configured to wirelessly communicate with other devices. The memory contains an application. The receiver receives an access request from a user device and the transmitter wirelessly communicate payload to a lock for unlocking the lock when the processor invokes the application in the memory and thereby determines that the received access request is an authorized request.

In an example embodiment having one or more features of the device of the previous paragraph, the transmitter transmits a communication to the user device indicating that the access request was denied when the processor determines that the access request was not an authorized request.

In an example embodiment having one or more features of the device of any of the previous paragraphs, the memory includes a plurality of authorized access request codes and the processor is configured to determine whether the received access request is an authorized request by comparing a code of the received access request with the stored authorized access request codes.

In an example embodiment having one or more features of the device of any of the previous paragraphs, the receiver receives the plurality of authorized access request codes from a first user device or a remote server.

In an example embodiment having one or more features of the device of any of the previous paragraphs, the wireless communications include a close range communication protocol.

An example embodiment having one or more features of the device of any of the previous paragraphs includes a housing configured to be mounted to a portion of a building near the lock.

An example embodiment having one or more features of the device of any of the previous paragraphs includes a housing configured to be secured to a portion of a vehicle that includes the lock.

An illustrative example access management system includes the access management device of any of the previous paragraphs and a server that communicates with other devices to provide the other devices with information regarding authorized access requests.

In an example embodiment having one or more features of the system of the previous paragraph, the server communicates with the access management device to install the application in the memory.

An illustrative example method of managing access to an area secured by a lock includes storing an application in memory of an access management device based on a communication from a first user device, receiving an access request from a second user device, using the application in the memory for determining whether the received access request is an authorized request, and using the application in the memory for transmitting payload to the lock for unlocking the lock when the received access request is an authorized request.

An example embodiment having one or more features of the method of the previous paragraph includes transmitting a communication to the second user device when the access request was determined to be an unauthorized request.

An example embodiment having one or more features of the method of any of the previous paragraphs includes obtaining a plurality of authorized access request codes and determining whether the received access request is an authorized request by comparing a code of the received access request with the obtained authorized access request codes.

In an example embodiment having one or more features of the method of any of the previous paragraphs, obtaining the plurality of authorized access request codes comprises communicating with a server that provides the codes.

An example embodiment having one or more features of the method of any of the previous paragraphs includes providing the second user device with at least one authorized access request code from a server remote from the access management device.

An example embodiment having one or more features of the method of any of the previous paragraphs includes unlocking the lock to provide access to one of a vehicle or a building.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an access management system designed according to an embodiment of this invention.

FIG. 2 schematically illustrates an access management device designed according to an embodiment of this invention.

FIG. 3 is a flow chart diagram summarizing an example access management method.

### DETAILED DESCRIPTION

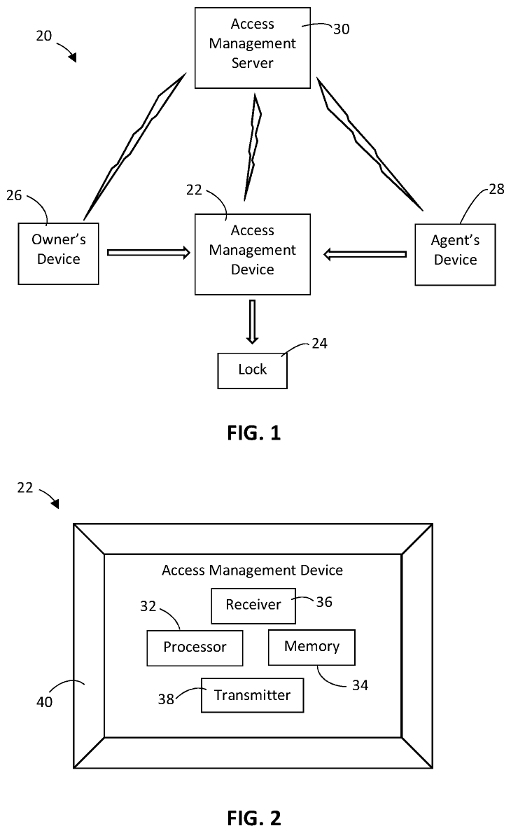

FIG. 1 schematically illustrates an access management system 20 that allows individuals to gain access to a locked space, such as the interior of a building or vehicle. An access management device 22 is configured to communicate with other devices including a lock 24, a first user device 26, and a second user device 28. The system 20 also includes an access management server 30.

When the access management device 22 is used to unlock a door to a building the first user device 26 will usually be an owner's or custodian's device such as a mobile phone and the second user device 28 will usually be owned or used by a real estate agent. When the access management device 22 is used to unlock a door to a vehicle the first user device 26 will usually be used by a dealer representative or custodian of vehicles in inventory and the second user device 28 will usually be a sales person's or customer's device. In some embodiments the first user device 26 is a mobile station, such as a cell phone. In other embodiments, the first user device 26 is a computing device that communicates with the access management device over a Wi-Fi or wireless local area network connection. In most implementations the second user device 28 will be a mobile station such as a smartphone. These examples are not intended to be limiting.

FIG. 2 schematically illustrates selected portions of an example embodiment of an access management device 22. A processor 32 is associated with memory 34. The processor 32 is configured or programmed to invoke an application in the memory 34 to perform certain functions to allow for access to a space protected by the lock 24 when appropriate criteria are satisfied.

A receiver 36 is configured to receive wireless communications from other devices, including the first user device 26 and the second user device 28. In some embodiments, the receiver 36 is also configured to communicate directly with the access management server 30.

A transmitter 38 is configured to wirelessly communicate with other devices including the lock 24 (from FIG. 1). In some embodiments, the transmitter 38 also communicates with the owner's device 26, the agent's device 28, and the access management server 30.

The processor 32, memory 34, receiver 36 and transmitter 38 are illustrated as individual components for discussion purposes. In some embodiments a microprocessor device may include the receiver and transmitter capabilities of the example access management device. Similarly, the memory 34 and the processor 32 may be part of a single device or be separate components.

The access management device 22 includes a housing 40 that is configured to be situated upon or mounted on a portion of a building that includes an entrance locked by the lock 24. For example, the housing 40 may include a hook or bracket for hanging the access management device 22 on a door handle. In other embodiments, the housing 40 includes adhesive or suction-based mounting features to secure the housing 40 to a flat surface, for example. In some instances, the access management device 22 is supported on a portion of a vehicle and the lock 24 is incorporated into a door of the vehicle.

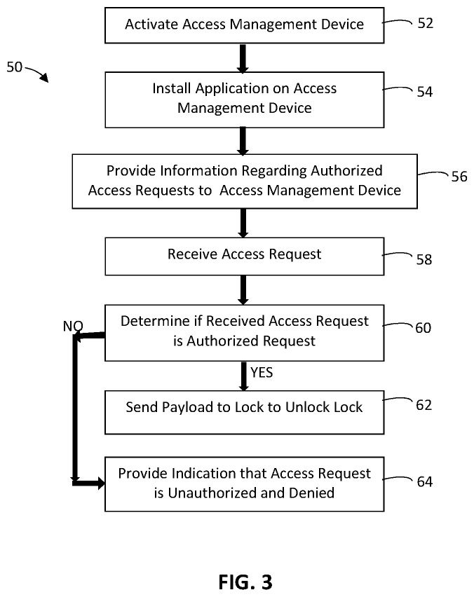

FIG. 3 is a flowchart diagram 50 that summarizes an example method of managing access to the space protected by the lock 24. At 52, the owner of the access management device 22 or an authorized individual activates that device. In the illustrated example embodiment, the owner uses the first user device 26 to communicate wirelessly with the access management device 22 for purposes of activating the latter.

At 54, the owner provides an application to the access management device 22 from or through the first user device 26. For example, the first user device 26 may be capable of sharing an application from the first user device 26 with the access management device 22. This approach allows the access management device 22 to clone the application previously stored on the first user device 26. In some embodiments the communication from the first user device 26 to the access management device 22 instructs the access management device 22 to download the application from the remote server 30.

The receiver 36 of the access management device receives the application and the processor 32 stores the received application in the memory 34. That application configures the devices 26 and 22, respectively, to communicate an appropriate payload to the lock 24 to unlock the lock 24 to provide access to the associated space, such as the interior of a building or a vehicle. In most cases, the application will be installed on the first user device 26 before being installed on the access management device 22. As part of the initiation or activation at 52 or part of the application provision at 54 the owner or user of the first user device 26 identifies the lock 24 so that the application saved in the memory 34 configures the access management device 22 to communicate with the lock 24. For example, the brand, model number or serial number of the lock 24 will identify the lock 24 sufficiently so that the access management device 22 will be able to provide the appropriate payload when the lock 24 should be unlocked. In many cases, the application will be specific to the lock 24 and initially obtained by the owner or user through the lock manufacturer.

At 56, the access management device 22 is configured to recognize an authorized access request. In some embodiments, the access management server 30 communicates directly with the access management device 22 over a cellular network connection, for example. In other embodiments, the access management server 30 communicates with the first user device 26 over a wireless cellular communication link, for example, to provide information for identifying authorized access requests to the first user device 26, which in turn provides that information to the access management device 22. In such embodiments, the first user device 26 communicates the authorized access request information to the access management device 22 over a close proximity communication link and the information is then stored in the memory 34.

Example embodiments include cookies installed in the memory 34 in association with or as part of the installed application. The cookies identify whether a particular access request is authorized. The cookies may be programmed into the access management device 22 or obtained from the server 30. In some embodiments the information pertaining to an authorized access request includes at least one authorized access code. Given this description those skilled in the art will realize how to configure the access management device 22 to be able to recognize appropriate requests for access that requires unlocking the lock 24.

Once the access management device 22 has been activated and provided with the application installed in the memory 34 that configures the access management device 22 to communicate the payload for unlocking the lock 24 and at least information for recognizing an authorized access request, it is possible for an individual other than the owner of the building or vehicle protected by the lock 24 to gain access to that building or vehicle by unlocking the lock 24 through communications with the access management device 22. For example, a real estate agent who desires to gain access to a home to show the home to a prospective buyer uses the second user device 28, such as smartphone, to communicate with the access management server 30. The second user device 28 has already stored an application received from the access management server 30 that configures the second user device 28 to communicate an authorized access request to the access management device 22. For example, the application on the second user device 28 may generate a communication including an access request code that corresponds to at least one authorized access request code stored in the memory 34 of the access management device 22. When the second user device 28 is brought in close enough proximity to the access management device 22, the second user device 28 transmits the access request to the access management device 22. The receiver 36 receives the access request at 58.

At 60, the processor 32 determines if the received access request is an authorized request. In embodiments using access request codes, the processor 32 compares the code of the received access request with authorized access codes in the memory 36. If the access request is authorized, at 62 the processor 32 causes the transmitter 38 to transmit the payload for unlocking the lock 24. The lock 24 responds to the received payload by unlocking, which allows access to the building.

The system 20 and the technique of unlocking the lock 24 provides security over the payload used for unlocking the lock 24. The agent using the second user device 28 never has access to the payload required by the lock 24 so it cannot be misused or shared with anyone else.

In some embodiments, an authorized access request code or identifier has a time limit and expires after an appropriate amount of time. In some embodiments, an authorized access request code can only be used from a particular agent's device 28 a predetermined number of times. In such embodiments, the processor 32 is able to determine an identity of the agent's device 28 based on information received by the receiver 36 when the agent's device 28 transmits the access request. The processor 32 determines whether the access code of that request has been transmitted by the agent's device 28 more than an authorized number of times. If so, the processor 32 determines that the access request should be denied as an unauthorized request even though the access code, itself, matches with an access code in the memory 34.

In some instances, the agent's device 28 will not transmit an authorized access request and when the processor 32 determines that there is no correspondence between a received access request code and any authorized codes within the memory 34, the processor 32 causes the transmitter 38 to provide an indication that the access request is unauthorized and denied at 64. Such an indication may be provided to the agent's device 28, the owner's device 26, the access management server 30, or all of them.

The illustrated example includes wireless communications between the devices 22, 26, and 28 that occur over a relatively close range using Wi-Fi, Bluetooth or a similar communication protocol. Communications between the access management device 22 and the lock 24 are wireless in this example and utilize a Bluetooth communication link, for example. Communications with the access management server 30 occur over a longer range and may utilize cellular network wireless communication links.

Embodiments of this invention, such as the disclosed example, provide security over a lock code used for a smart lock that can be unlocked without a physical key. The lock code is maintained secure because only the owner of the lock 24 knows the lock code. The individual using the agent's device 28 never gains access to the actual lock code. Additionally, the host of the server 30 need not obtain the lock code.

Another feature of embodiments of this invention is that an individual, such as a real estate agent, only needs to install a single application on the agent's device 28 to facilitate communications with the access management server 30 that allows that individual to communicate with a large number of access management devices to be able to unlock a large variety of different types of smart locks that operate without a physical key. It is not necessary for an individual agent to obtain a large number of lock codes nor is it necessary for an individual to download a large number of applications to be able to communicate with locks of various manufacturers.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-15. (canceled)

16. An access management device, comprising:
a processor;
memory associated with the processor;
a receiver configured to receive wireless communications; and
a transmitter configured to transmit wireless communications;
wherein
the processor is configured to install or activate an application in the memory in response to a command from a first user device,
the first user device is an authorized user device that is configured to wirelessly communicate payload to a lock for unlocking the lock,
the application configures the access management device to wirelessly communicate the payload to the lock for unlocking the lock,
the processor is configured to invoke the application in the memory to determine whether a wireless communication received by the receiver from a second user device is an authorized request,
the second user device is not configured to wirelessly communicate the payload to the lock, and
the processor is configured to cause the transmitter to wirelessly communicate the payload to the lock for unlocking the lock when the wireless communication received from the second user device is an authorized request.

17. The access management device of claim 16, wherein the transmitter transmits a communication to the second user device indicating that the access request was denied when the processor determines that the access request was not an authorized request.

18. The access management device of claim 16, wherein
the memory includes a plurality of authorized access request codes; and
the processor is configured to determine whether the received access request is an authorized request by comparing a code of the received access request with the stored authorized access request codes.

19. The access management device of claim 18, wherein the receiver receives the plurality of authorized access request codes from the first user device or a remote server.

20. The access management device of claim 16, wherein the wireless communications include a close range communication protocol.

21. The access management device of claim 16, comprising a housing configured to be mounted to a portion of a building near the lock.

22. The access management device of claim 16, comprising a housing configured to be secured to a portion of a vehicle that includes the lock.

23. An access management system, comprising:
the access management device of claim 16; and
a server that communicates with at least the second user device to provide the second user device with information regarding authorized access requests.

24. The access management system of claim 23, wherein the server communicates with the access management device to install the application in the memory.

25. A method of managing wireless activation of a lock, the method comprising:
storing or activating an application in memory of an access management device based on a communication from a first user device that is an authorized user device configured to wirelessly communicate a payload to the lock to unlock the lock, wherein the application configures the access management device to wirelessly communicate the payload to the lock for unlocking the lock;
receiving an access request by the access management device from a second user device that is not configured to communicate the payload to the lock to unlock the lock;
using the application in the memory for determining whether the received access request is an authorized request; and
transmitting the payload to the lock for unlocking the lock from the access management device when the received access request from the second user device is an authorized request.

26. The method of claim 25, comprising transmitting a communication to the second user device when the access request was determined to be an unauthorized request.

27. The method of claim 25, comprising
obtaining a plurality of authorized access request codes by the access management device; and
determining whether the received access request is an authorized request by comparing a code of the received access request with the obtained authorized access request codes.

28. The method of claim 27, wherein obtaining the plurality of authorized access request codes comprises communicating with a server that provides the codes.

29. The method of claim 25, comprising providing the second user device with at least one authorized access request code from a server remote from the access management device.

30. The method of claim 25, comprising unlocking the lock to provide access to one of a vehicle or a building.
